(19) United States
(12) Patent Application Publication
(10) Pub. No.: US 2012/0303649 A1
(43) Pub. Date: Nov. 29, 2012

(54) SYSTEM AND METHOD FOR FACILITATING USE OF A SELECTION GUIDE

(75) Inventor: Geoffry A. Westphal, Evanston, IL (US)

(73) Assignee: W.W. GRAINGER, INC., Lake Forest, IL (US)

(21) Appl. No.: 13/568,927

(22) Filed: Aug. 7, 2012

Related U.S. Application Data
(63) Continuation of application No. 11/158,039, filed on Jun. 21, 2005.

(51) Int. Cl. G06F 17/30

(52) U.S. Cl. 707/766; 707/E17.074

(57) ABSTRACT

A system and method functions to automatically invoke a selection guide when the search term(s) provided in a freeform search query are determined to be associated with a category of item for which a selection guide will provide the most efficient means for the user to locate items of interest.

### RELATED APPLICATION INFORMATION

This application is a continuation of U.S. application Ser. No. 11/158,039, filed on Jun. 21, 2005, the disclosure of which is incorporated herein by reference in its entirety.

### BACKGROUND

The following relates generally to e-commerce and, more particularly, relates to a system and method for facilitating use of a selection guide that provides a means to locate items of interest.

Systems and methods for searching electronic product catalogs to locate items of interest are well known in the art. For example, as described in the background section of U.S. Pat. No. 6,144,958, to perform a search using a search engine for the purpose of locating items of interest, a user submits a query containing one or more search terms. A query server program of the search engine then processes the query to identify any items that match the query. The set of items identified by the query server program is referred to as the “query result,” and is commonly presented to the user as a list of the located items. A significant disadvantage with the use of search engines, however, is that sometimes too many items may be found that satisfy the search query. In such a case the user is left in the unenviable position of having to navigate through many electronic records that are tangentially, if at all, related to the item or items the user was attempting to locate.

As an alternative to allowing a user to use a freeform search to locate items of interest it is also know to make selection guides available to a user. In this regard, a selection guide, an example of which is disclosed in U.S. Pat. No. 4,992,940, is generally a template in which a user provides specifications for the item that is of interest to the user. In conventional practice, a user manually invokes a selection guide by activating a hyperlink associated with a category of product and the system responds by displaying the relevant selection guide template. The user then fills in one or more blank spaces of the template to tell the system the minimum desired specifications for the item the user is attempting to locate. A computer will then search the product catalog to retrieve all items having the specifications required by the user and the user can then request more detailed information about a particular item and/or select one or more retrieved items for immediate purchase. While selection guides do work for their intended purpose, current e-commerce systems suffer the disadvantage of either being limited to using only selection guides or requiring that a user know that such selection guides exist on the e-commerce system and what actions are required to manually initiate their use.

### SUMMARY

To address these and other disadvantages associated with current e-commerce systems, disclosed hereinafter is a system and method for facilitating use of a selection guide that provides a means for a user to locate items of interest. More particularly, the system and method functions to automatically invoke a selection guide when the search terms(s) provided in a freeform search query are determined to be associated with a category of item for which a selection guide will provide the most efficient means for the user to locate items of interest. To this end, the system and method compares the search term(s) entered into the freeform search query with a listing of keyword(s) that have been associated with a selection guide. In the event a search term(s) provided by the user finds a match within the listing of keyword(s) that have been associated with a selection guide, the corresponding selection guide may be automatically launched. Prior to the launching or invocation of the selection guide, the user may be presented with the option of, for example, seeing the search results for the search query provided by the user to thereby allow the user to bypass, if the user so desires, the selection guide search process. Similarly, if it is determined that the search query will provide search results that are of sufficiently narrow scope so as to not frustrate the user, e.g., the search results return less than a predetermined number of items, the search results may be provided to the user in lieu of automatically launching the selection guide. Still further, in some cases, one or more of the search terms provided by the user as part of the search query may be utilized to pre-populate and/or limit available fields of the template that is used in connection with the selection guide.

A better understanding of the objects, advantages, features, properties and relationships of the systems and methods described hereinafter will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the systems and methods described hereinafter reference may be had to preferred embodiments shown in the following drawings in which:

FIG. 1 is a block diagram illustrating an exemplary computer system in which the principles of the described invention may be employed;

FIG. 2 is a screen shot illustrating an exemplary home page including drill down search links and a free form query entry field;

FIGS. 3-5 are screen shots illustrating an exemplary drill down process for locating items of interest to a user;

FIG. 6 is a screen shot illustrating an exemplary selection guide, particularly useful for searching for casters;

FIGS. 7A and 7B are screen shots illustrating an exemplary selection guide selection screen and an exemplary selection guide, respectively, particularly useful for searching for lamps;

FIGS. 8A-8C are screen shots illustrating an exemplary selection guide, parameter specification fields within a selection guide, and display of a selection guide with parameters having been specified, respectively, particularly useful for searching for motors;

FIG. 9 is a flow chart diagram illustrating an exemplary method for launching a selection guide considering search terms provided by a user within a free form search query;

FIG. 10 is a flow chart diagram illustrating a further exemplary method for launching a selection guide considering search terms provided by a user within a free form search query;

FIGS. 11-13 are screen shots illustrating an exemplary selection guide with selected parameter fields being pre-populated based upon the search terms provided by a user within a free form search query; and

FIG. 14 is a flow chart diagram illustrating a still further exemplary method for launching a selection guide considering search terms provided by a user within a free form search query.

### DETAILED DESCRIPTION

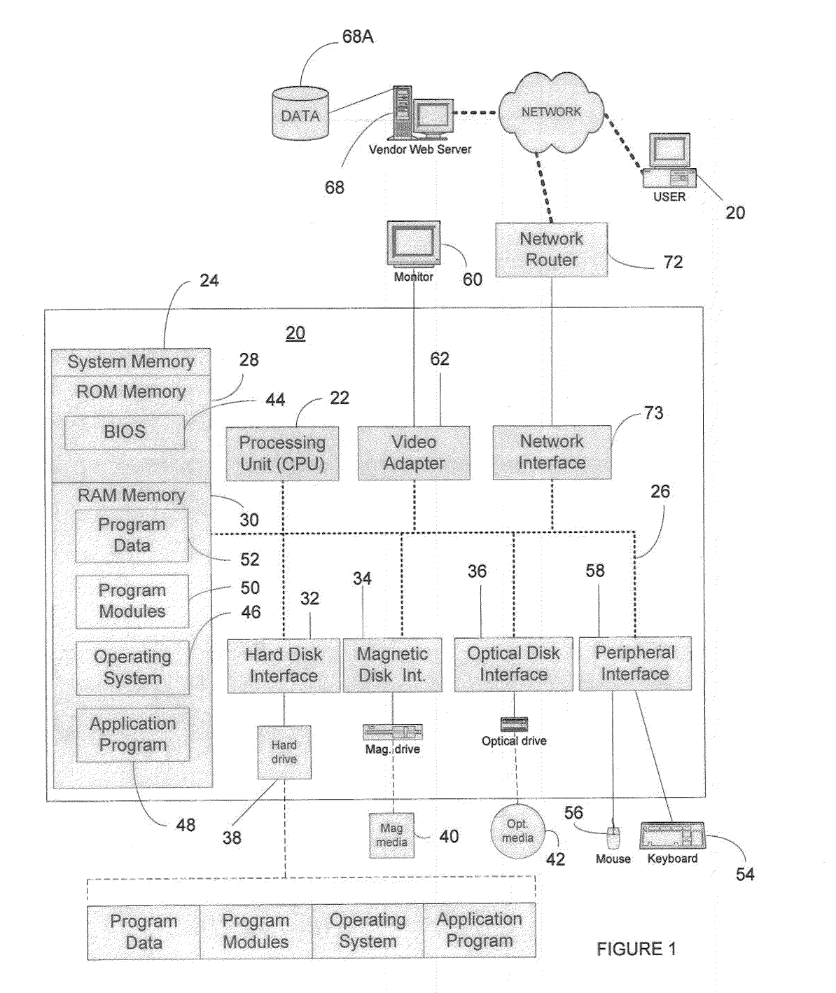

Turning to the drawings, wherein like reference numerals refer to like elements, an exemplary system and method for providing a response to a search query is described. In particular, as illustrated in FIG. 1, the system and method will be described in the context of a plurality of processing devices linked via a network, such as the World Wide Web or the Internet. In this regard, a processing device 20, illustrated in the exemplary form of a computer system, is provided with executable instructions to, for example, provide a means for a user to access a vendor server 68 and thereby perform a search for items. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

An end-user may enter commands and information into the processing device 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the vendor server 68 having associated data repository 68A. In this regard, while the remote processing device 68 has been illustrated in the exemplary form of a computer, it will be appreciated that the remote processing device 68 may, like processing device 20, be any type of device having processing capabilities. Again, it will be appreciated that the remote processing device 68 need not be implemented as a single device but may be implemented in a manner such that the tasks performed by the remote processing device 68 are distributed to a plurality of processing devices linked through a communication network

For performing tasks as needed, the remote processing device 68 may include many or all of the elements described above relative to the processing device 20. By way of further example, the remote processing device 68 may include the executable instructions for handling search requests and providing search results. Communications between the processing device 20 and the remote processing device 68 may be exchanged via a further processing device, such a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the remote processing device 68.

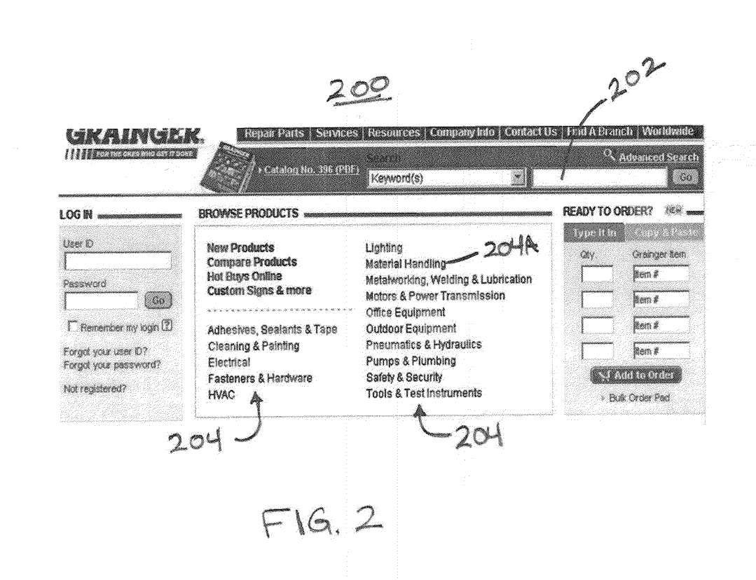

To assist a user in locating one or more items of interest, the user is preferably provided with a search page 200, an example of which is illustrated in FIG. 2. The search page 200 may be accessed by establishing a communication link with the vendor Web server 68 whereupon the vendor Web server 68 may return the search page 200 to the requesting computer 20 for presentation to the user. While the search page 200 and resulting Web pages may be retrieved from the vendor Web server 68, it will be appreciated that search page 200 as well as additional pages displayed to the user may be local to a computer being used by a user, e.g., by being stored on a readable media such as optical media 42.

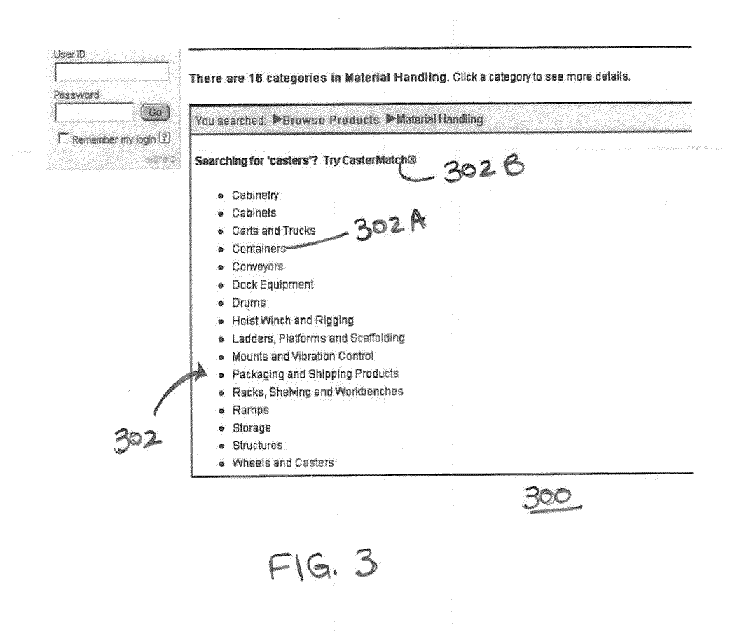

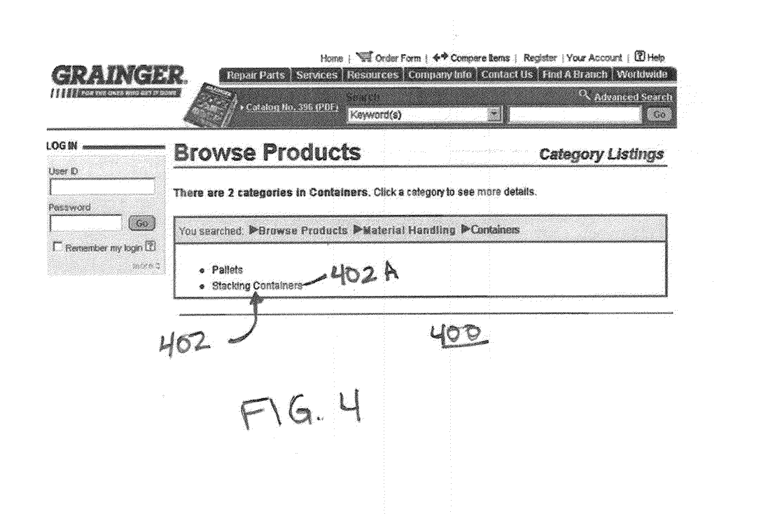

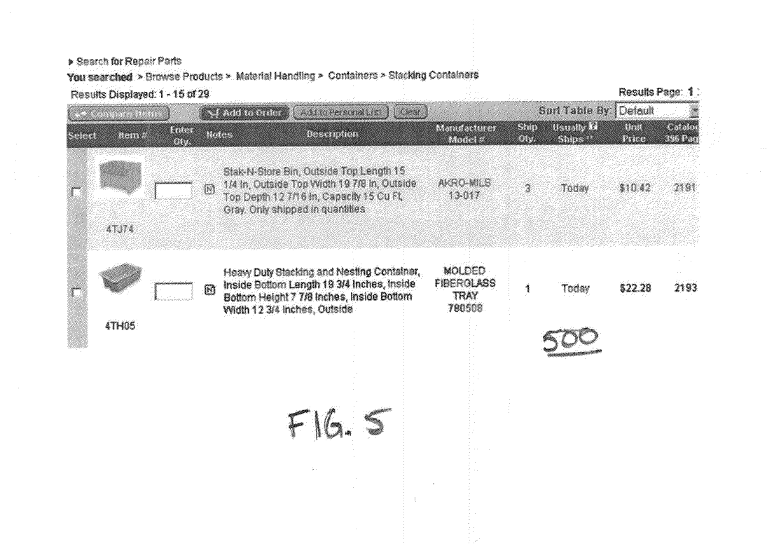

As illustrated, the search page 200 includes a query entry field 202 in which a user can enter a freeform search query, comprised of one or more search terms, for use in connection with a search engine. In addition, the search page 200 may include one or more category hyperlinks 204 which may be activated by a user to further drill down into predefined categories of products within the item catalog of the vendor. For example, should the user activate the “material handling” hyperlink 204A, the user may be presented with a “material handling” sub-category search page 300, an example of which is illustrated in FIG. 3. The sub-category search page 300 functions to present to the user sub-category hyperlinks 302 relevant to the selected category of “material handling.” As will be understood, the user may activate the sub-category hyperlinks 302 to continue with the guided search. By way of illustration, the user may activate the “containers” sub-category hyperlink 302A which, in this case, presents to the user a still further sub-category page 400, illustrated in FIG. 4, including further sub-category hyperlinks 402, and, in response to the user then selecting the further sub-category “stacking containers” hyperlink 402A, the user may then be presented with an item search result page 500 which presents to the user those items that are relevant to the keywords selected using the guided search, i.e., the items within the “material handling” category, the “containers” sub-category, and the “stacking containers” further sub-category as illustrated in FIG. 5. As will be understood, from the item search result page 500, the user may retrieve further information concerning an item of interest, place the product into a shopping cart for possible purchase, etc.

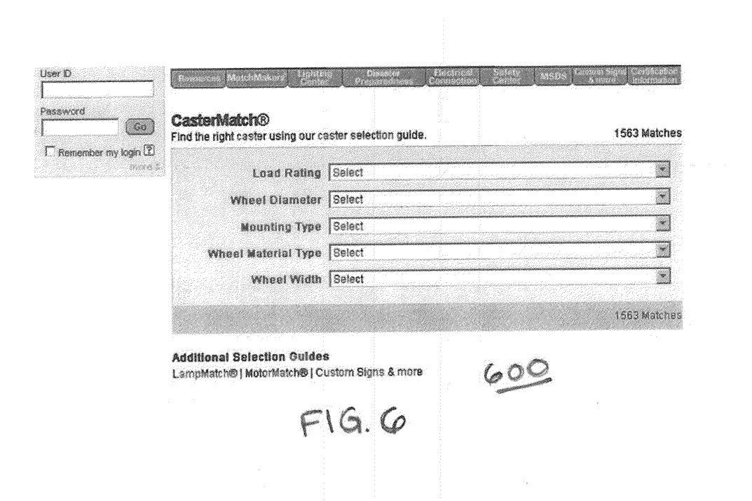

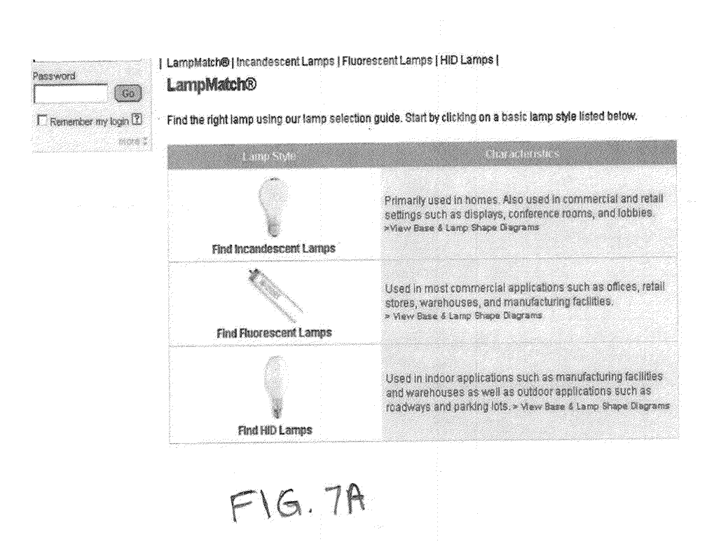

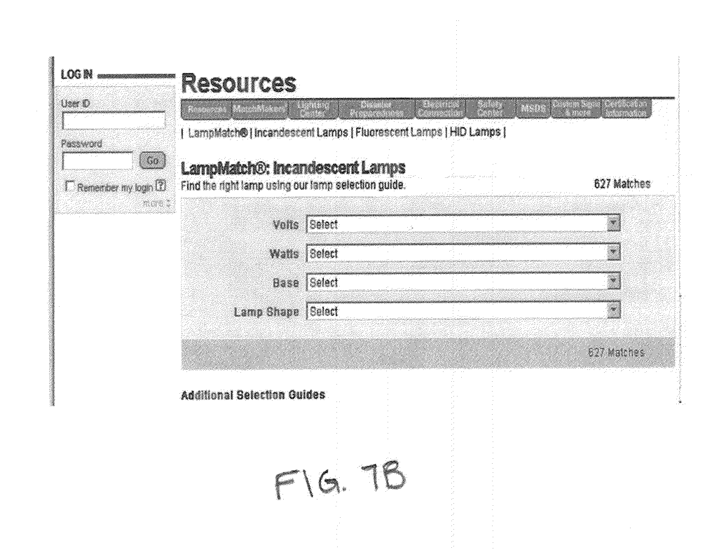

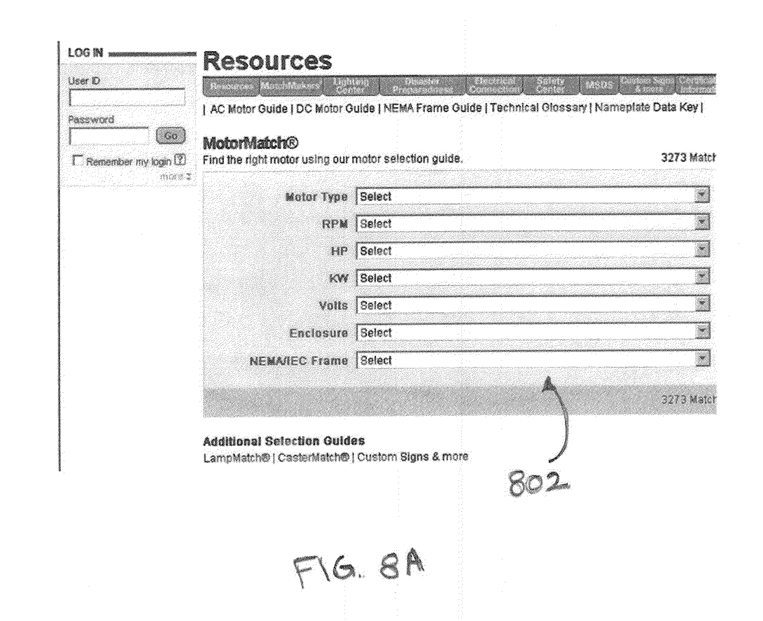

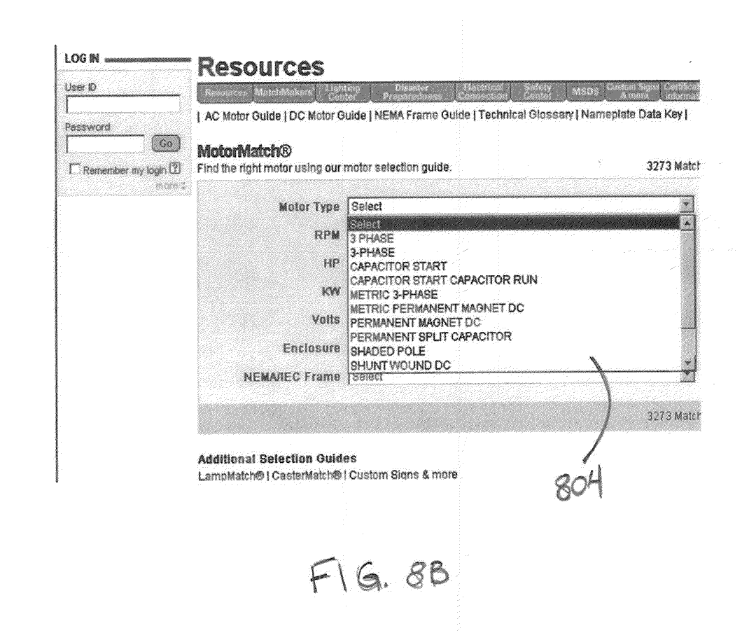

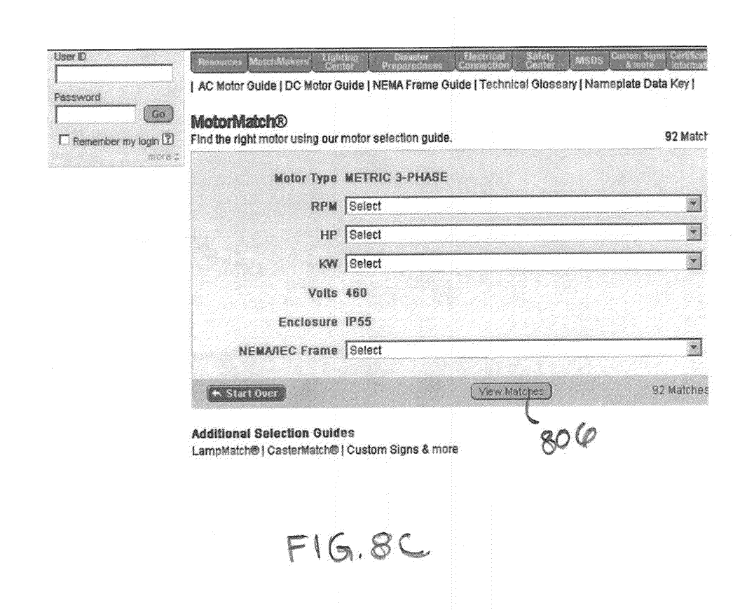

In addition to providing hyperlinks to guide a user through a search for items of interest, the system may also provide one or more hyperlinks which, when discovered by the user, may be manually activated to instantiate a category relevant selection guide. For example, a user may activate selection guide hyperlink 302B to instantiate the CasterMatch® selection guide 600, illustrated by way of example in FIG. 6. Similarly, a user may activate other selection guide hyperlinks to instantiate other category relevant selection guides such as the LampMatch® selection guide, illustrated by way of example in FIGS. 7A and 7B (where FIG. 7A illustrates a plurality of lamp selection guides available to a user and FIG. 7B illustrates a selected one of the plurality of lamp selection guides), or the MotorMatch® selection guide, illustrated by way of example in FIGS. 8A-8C.

As will be appreciated, the selection guides provide a means for guiding a user through a search for items of interest, in particular, by providing a template by which a user may specify minimum requirements for an item of interest. For example, as illustrated in FIGS. 8A-8C, a user may specify the minimum requirements for an item of interest by populating one or more of various fields 802 in a selection guide template by selecting a requirement from a menu 804, as illustrated in FIG. 8B. It will also be appreciated that a selection of a requirement from a menu 804 of requirements available for a particular template field 802 may also function to automatically complete or eliminate other fields 802 within the selection guide template, as further illustrated in FIG. 8C, e.g., the selection of a user of “metric 3-phase” in the motor field results in the volts field and the enclosure field being pre-populated to “460” and “IP55,” respectively, which are the only valid parametric values for those fields give the initial selection of the user. Once the user has specified the requirements of interest, the user may then activate a hyperlink 806 to cause the search terms/parameter values that have been established within the selection guide to be provided to the search engine with the results, e.g., an items page, being returned to the user.

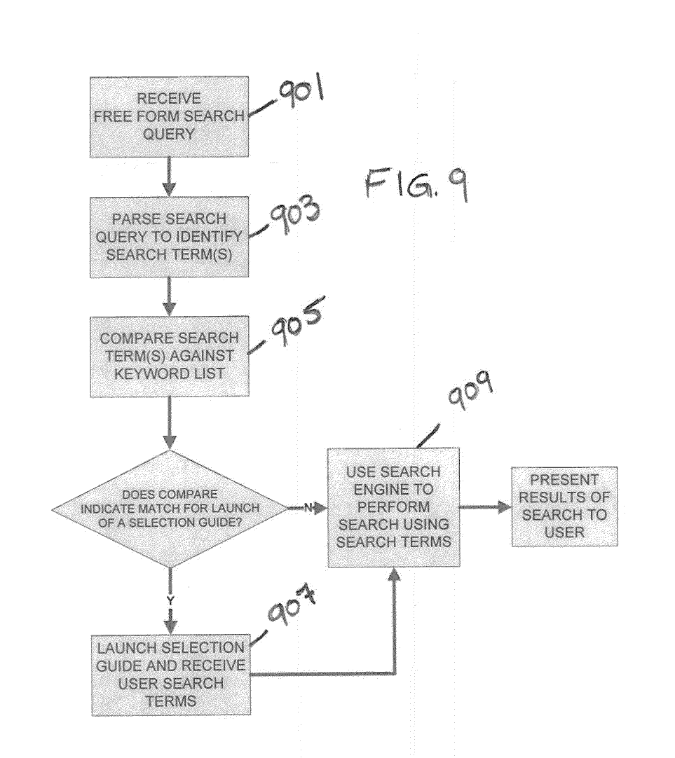

To ensure that a user is made aware of and/or directed toward the use of a selection guide, especially in cases where it is felt that a selection guide would provide the best means for the user to quickly obtain the results desired, the system further provides for the automatic launching of a selection guide. To this end, as generally illustrated in FIG. 9, it may be desired to provide access to a selection guide in response to a user entering a free form search query that includes search terms that are indicative of a user searching for a type of product that is amenable to being identified through the use of a selection guide, e.g., a product within a predefined category such as casters, motors, lamps, fasteners, etc. More particularly, once a user has entered a search query comprised of one or more search terms 901, the illustrated system functions to parse the search query 903 to isolate the various search terms which parsed search terms are then compared 905 against a listing of keywords, e.g., numbers, units of measure, alphanumeric descriptors, etc., that have been associated with a selection guide. The keyword listing may be created by, for example, examining the search terms in prior search queries entered by users. If a search term within the search query matches a keyword within the listing of keywords the system may function to automatically present to the user a selection guide 907 and, in the case where more than one selection guide is available, the selection guide that has been associated with the particular keyword that was matched. The user may then interact with the selection guide in a conventional manner to locate the item(s) of interest to the user. If no search term within the search query matches a keyword within the listing of keywords, the search query may then be provided to the search engine 909 for processing in a conventional manner.

It will be appreciated that it may be desirable to provide the user with a notice prior to automatically launching the selection guide. For example, in the case where the motor selection guide is determined to be the relevant selection guide based upon the search terms provided within the search query, e.g., the user query was “motor,” “motors,” “electric motor,” “electric motors,” “AC motor,” “AC motors” or “200 hp 1200 rpm,” the user may be presented with a notice such as “it appears that you are searching for a motor, would you like to use the motor selection guide?” In such a case, if the user elects not to use the motor selection guide, the search query may again be provided to the search engine for processing in a conventional manner.

In circumstances where multiple selection guides are available for launching when the search query is considered by the system, it will be appreciated that it might be desirable to provide a mechanism for reconciling any conflicts or ambiguities that may arise. Such ambiguities may arise if, for example, the search term(s) within the search query match keyword(s) that have been associated with different selections guides. To resolve any such conflict, the system may simply prompt the user to select for use one of the selection guides selected by the system. For example, in response to an ambiguous search term like “115 Volts,” which may be a reference to a parameter associated with a lamp or a motor, the system may provided the user with the opportunity to select between a lamp selection guide or a motor selection guide. The system may also be programmed to simply select for invocation that selection guide that has been associated with a keyword that was last, first, or other matched when compared against the search terms, i.e., the order of the search terms within the query is used to establish a context for the category of product of interest to the user with that determined context being used to launch an appropriate selection guide. For example, the search query “115V incandescent” might cause the launching of the lamp selection guide as the position of “incandescent” within the search query signifies to the system the context of lamps. Still further, the system may be programmed to select for invocation that selection guide that has been associated with the most keywords that have been matched, i.e., the number of the search terms within the query that are contextually related is used to establish an overall context for the category of product of interest to the user with that determined overall context being used to launch an appropriate selection guide. Yet further, the system may be programmed to make a decision as to what selection guide should be launched considering, for example, parametric values that have entered into the search query which may signify an overall context of the search (e.g., if a value is one that falls within a range for a parameter of one possible selection guide but not within a range for a parameter of another possible selection guide, the system may launch the selection guide that supports the user entered value).

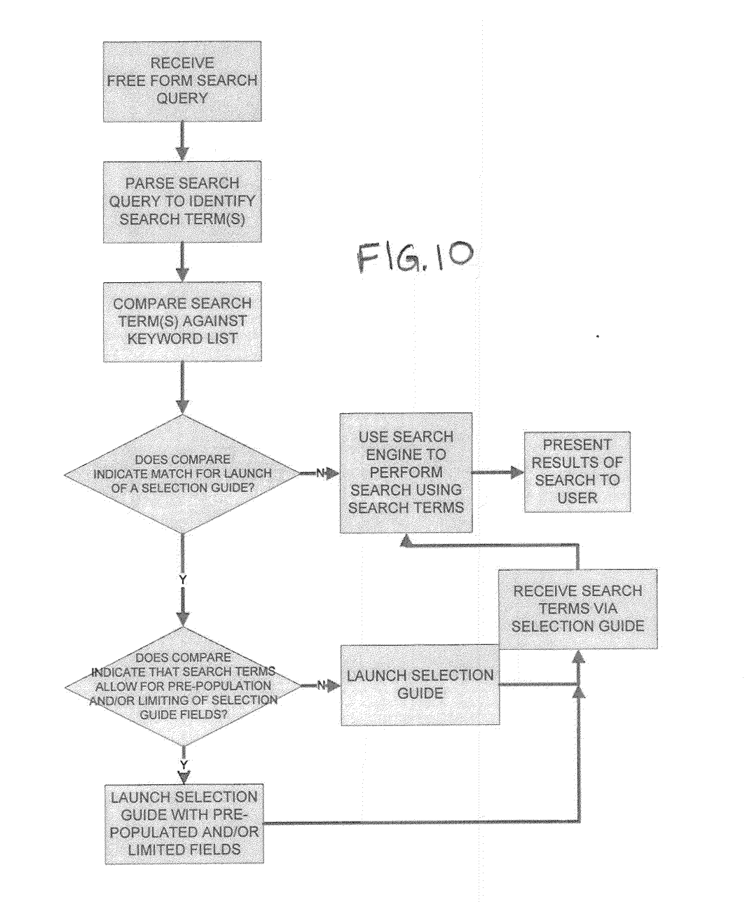

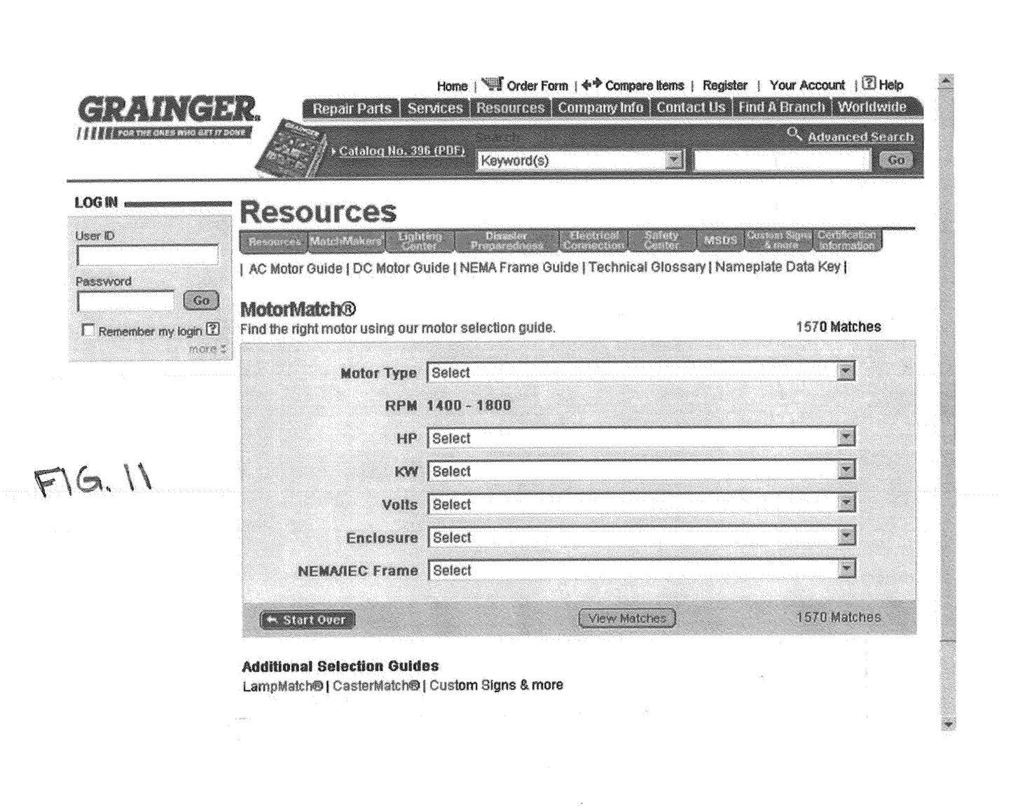

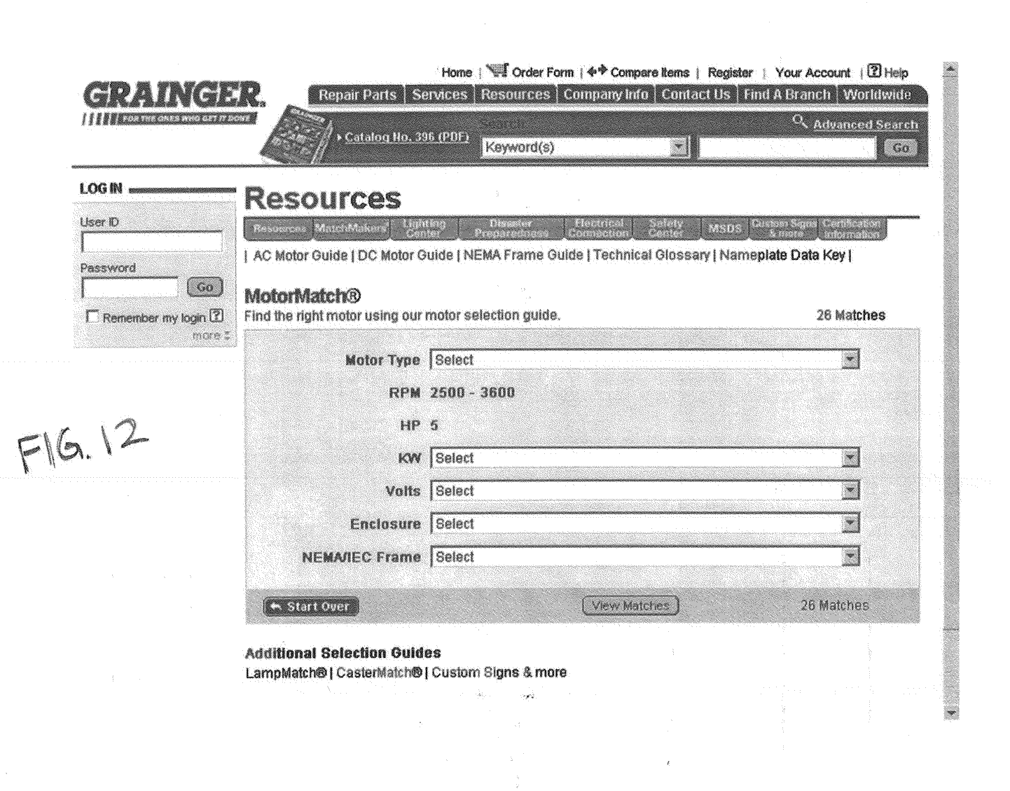

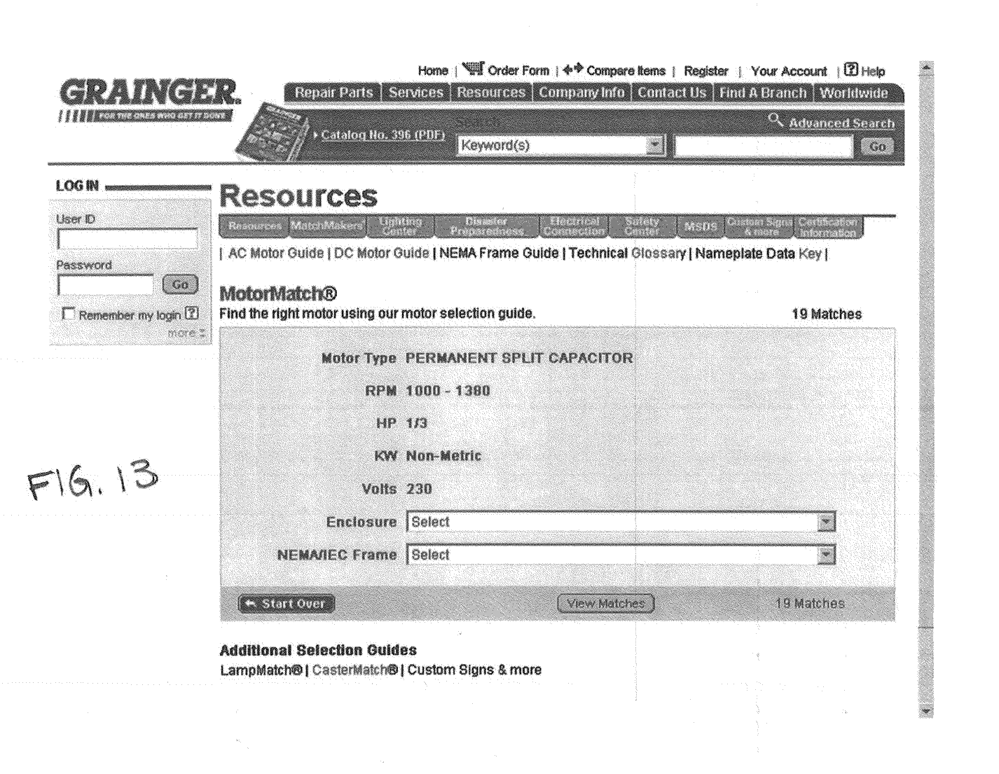

While parametric values specified as a part of a search query, e.g., “rpm” which signifies to the system the context of motor, may result in the system selecting an appropriate selection guide for launching, it is contemplated that the system may use parametric values entered within a search query to also pre-populate a selection guide that is launched. To this end, the specified parametric values may be automatically entered within appropriate selection guide fields, may cause the removal of non-relevant fields from the selection guide, etc. For example, as generally illustrated in FIG. 10, if the user should enter the search query “1725 rpm motor,” “3450 rpm motor,” or “1750 rpm motor,” the system would: a) determine based upon the use of the search query term “motor” (or “rpm” in this example) that the motor selection guide should be the selection guide to launch, e.g., the search query term “motor” (and/or “rpm”) matches a keyword that has been associated within the system to the motor selection guide; b) determine that the search query term “rpm” matches a parametric field within the relevant selection guide; and c) determine that the search query terms “1725,” “3450,” or “1750” appears to be associated with a parametric field within the relevant selection guide to thereby allow the use of the specified value within the relevant parametric field within the relevant selection guide. Based upon these determinations, the system may present to the user the motor selection guide with the rpm field being pre-populated with the range 1400-1800 as illustrated in FIG. 11. By way of further example FIG. 12 illustrates a motor selection guide having multiple fields that have been pre-populated in response to a user searching with the search query “5hp motor 3600 rpm” and FIG. 13 illustrates a motor selection guide having multiple fields that have been pre-populated in response to a user searching with the search query “1/3 hp rpm 1075 230 volt.” As concerns the example illustrated in FIG. 13, it will be noticed that the system has additionally pre-populated the parameter fields “motor type” and “KW” with values since the system has recognized that only one valid value for these fields is available based upon the values for the parameters that have been used in the pre-population of the selection guide. By way of yet further example, while a search query using “lamp” or “lamps” may direct the user to the general lamp selection guide page illustrated in FIG. 7A, should the user enter the search query “incandescent lamp,” “lamp incandescent,” “incandescent lamps,” or “lamps incandescent,” the user may be taken directly to the appropriate selection guide such as illustrated in FIG. 7B.

In some instances the system might be programmed to ignore one or more parametric values entered by a user in a search query where, for example, the parametric values would not all be capable of being used within the selection guide (e.g., the user specified “metric 1/3 hp rpm 1075 230 volt” it being seen from FIG. 13 that “non-metric” is the only valid value for the “kw” field based upon the other user provided parametric values). In such cases, the system may choose to ignore all the parametric values provided by a user and just launch an appropriate selection guide with no fields pre-populated. The system may also select to use parametric value(s) to pre-populate the fields of a selection guide based upon a weighting system, e.g., a specified motor type is more important than a specified rpm which is more important than a specified HP, etc. In this instance, the system may still use those specified parameters to pre-populate the fields of a selection guide that have a lesser weight and which do not conflict with those specified parameters having a heavier weight.

With respect to determining whether a search query term is indicative of a parametric field within a selection guide, it will be appreciated that a keyword list may be prepared that functions to associate a search query term or search query phrase, i.e., multiple terms within the search query, with one or more parametric fields within a selection guide. It will also be appreciated that the keywords within the keyword list need be limited to the specific labels provided to the parametric fields within a selection guide. Rather, when a search query functions to specify an intended use for a product, a brand name of a product, etc., it might be possible to use the information provided within the search query to pre-populate a selection guide. For example, if the user were to specify “dry wall fastener” a fastener selection guide could be launched with the fastener type field pre-populated with “screw,” and the head type field pre-populated with “countersunk.” A similar operation could occur should a user query using “oil burner motor,” “air compressor motor,” “pool pump motor,” “farm duty motor,” etc.

With respect to determining if a query term, e.g., a number or descriptor such as “split capacitor,” appears to be indicative of a parametric value that matches a parametric field within the relevant selection guide, the system may compare the query term to keywords (especially useful when the value is a textual descriptor) and/or consider the order in which the search terms appear within the query (especially useful when the value is numerical). For example, the system may designate a numerical value positioned adjacent to or included as a part of a search term that itself is indicative of a parameter within a selection guide as being indicative of a value for use within a corresponding parametric field within that selection guide. Thus, it will also be appreciated that the parsing operation may have the intelligence to consider search terms that have not been specified using a space, e.g., “1/3HP” and “1/3 HP” would be parsed to provide the same results. Still further, if only one numerical value and only one search query term that matches a parametric field within the relevant selection guide are specified, the system may simply assume that the value is intended to specify a value for that parameter. Yet further, in cases where the query term specifies a value for a parameter, e.g., a descriptor or a numerical value, that could only fall within the parametric values available for a parametric field of given selection guide, the system may simply assume that the query term was intended to specify a value for that parameter and so pre-populate the appropriate parameter field within that selection guide using said query term.

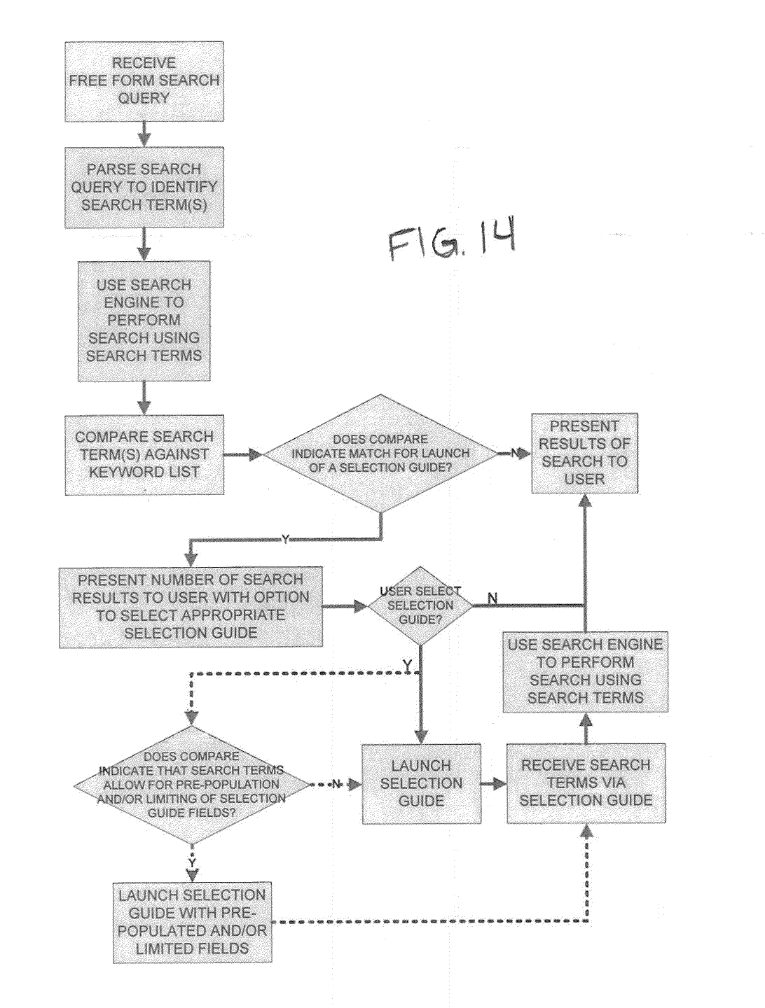

In still further circumstance, it may be desirable to allow the user to see the number of search results that result from the user entered search query with the user then being provided with an option to launch a selection guide determined to be appropriate based upon the query terms or to view the search results, as illustrated in FIG. 14. Still further, this process may be automated such that, if the number of search results are determined to be sufficiently narrow, e.g., less than a predetermined number, the user would be taken directly to the search results rather than the appropriate selection guide being launched.

While specific embodiments of the invention have been described in detail, it will be appreciated by those skilled in the art that various modifications and alternatives to those details could be developed in light of the overall teachings of the disclosure. For example, it will be appreciated that the initial search request may originate via a phone call, email, etc. with a sales representative using the system to provide results and/or guide the requester with further questions to obtain the desired results. Similarly, the various search pages, item database, and search engine could be located locally with respect to a computer being used to perform the searching with only actual orders for products being communicated to the vendor, such as by being uploaded to the vendor Web server. Still further, it will be understood that the various steps illustrated in the figures and described herein need not be performed in the exact order set forth within this document. Accordingly, the particular arrangements disclosed are meant to be illustrative only and not limiting as to the scope of the invention which is to be given the full breadth of the appended claims and any equivalents thereof.

All patents, patent applications, and other references cited within this document are hereby incorporated by reference in their entirety.

What is claimed is:

1. A non-transitory computer readable media having stored thereon executable instructions which, when executed by a processing device, performing steps comprising:
examining a search query which includes a numeric value to determine if the numeric value is uniquely used as a searchable term for identifying items within a one of a plurality of types of items within an electronic catalog of items; and
when the numeric value is uniquely used as a searchable term for identifying items within a one of a plurality of types of items within an electronic catalog of items, automatically causing a presentation of a selection guide usable to search for items within the one of a plurality of types of items within the electronic catalog of items that have an associated parametric value that corresponds to the numeric value included in the search query.

2. The non-transitory computer readable media as recited in claim 1, wherein an appropriate field in the selection guide is automatically populated with the parametric value that corresponds to the numeric value included in the search query.

3. The non-transitory computer readable media as recited in claim 2, wherein the instructions cause a removal of one or more fields in the selection guide that are determined to be non-relevant considering the numeric value included in the search query.

4. The non-transitory computer readable media as recited in claim 1, wherein determining if the numeric value is uniquely used as a searchable term for identifying items within a one of a plurality of types of items within an electronic catalog of items comprises determining if the numeric value is within a range for a parametric value that is uniquely used as a searchable term for identifying items within a one of a plurality of types of items within an electronic catalog of items.

5. A non-transitory computer readable media having stored thereon executable instructions which, when executed by a processing device, performing steps comprising:
examining a search query which includes a numeric value to determine if the numeric value is uniquely used as a searchable term for identifying items within a one of a plurality of types of items within an electronic catalog of items;
when the numeric value is uniquely used as a searchable term for identifying items within a one of a plurality of types of items within an electronic catalog of items determining if a number of items within the one of a plurality of types of items within an electronic catalog of items that have an associated parametric value that corresponds to the numeric value included in the search query is less than a predetermined number of items; and
when the number of items within the one of the plurality of types of items with an electronic catalog of items that have an associated parametric value that corresponds to the numeric value included in the search query is less then the predetermined number of items, automatically presenting as a search result information for each item within the one of a plurality of types of items within an electronic catalog of items that have an associated parametric value that corresponds to the numeric value included in the search query.

6. A non-transitory computer readable media having stored thereon executable instructions which, when executed by a processing device, performing steps comprising:
examining a search query which includes a numeric value to determine if the numeric value is uniquely used as a searchable term for identifying items within a one of a plurality of types of items within an electronic catalog of items; and
when the numeric value is uniquely used as a searchable term for identifying items within a one of a plurality of types of items within an electronic catalog of items, automatically presenting an indication of a number of items within the one of a plurality of types of items within an electronic catalog of items that have an associated parametric value that corresponds to the numeric value included in the search query.

7. The non-transitory computer readable media as recited in claim 6, wherein the instructions automatically provide for presentation as a search result information for each item within the one of a plurality of types of items within an electronic catalog of items that have an associated parametric value that corresponds to the numeric value included in the search query when the number of items within the one of a plurality of types of items within an electronic catalog of items that have an associated parametric value that corresponds to the numeric value included in the search query is less than a predetermined number of items.

8. The non-transitory computer readable media as recited in claim 6, wherein the instructions provide for an automatic presentation of a selection guide usable to search for items within the one of a plurality of types of items within an electronic catalog of items that have an associated parametric value that corresponds to the numeric value included in the search query.

9. The non-transitory computer readable media as recited in claim 8, wherein an appropriate field in the selection guide is automatically populated with the parametric value that corresponds to the numeric value included in the search query.

10. The non-transitory computer readable media as recited in claim 9, wherein the instructions cause a removal of one or more fields in the selection guide that are non-relevant considering the numeric value included in the search query.

11. The non-transitory computer readable media as recited in claim 6, wherein determining if the numeric value is uniquely used as a searchable term for identifying items within a one of a plurality of types of items within an electronic catalog of items comprises determining if the numeric value is within a range for a parametric value that is uniquely used as a searchable term for identifying items within a one of a plurality of types of items within an electronic catalog of items.

12. The non-transitory computer readable media as recited in claim 11, wherein the instructions provide for an automatic presentation of a selection guide usable to search for items within the one of a plurality of types of items within an electronic catalog of items that have an associated parametric value that corresponds to the numeric value included in the search query.

13. The non-transitory computer readable media as recited in claim 12, wherein an appropriate field in the selection guide is automatically populated with the parametric value that corresponds to the numeric value included in the search query.

14. The non-transitory computer readable media as recited in claim 13, wherein the instructions cause a removal of one or more fields in the selection guide that are non-relevant considering the numeric value included in the search query.

15. The non-transitory computer readable media as recited in claim 11, wherein the instructions automatically provide for presentation as a search result information for each item within the one of a plurality of types of items within an electronic catalog of items that have an associated parametric value that corresponds to the numeric value included in the search query when the number of items within the one of a plurality of types of items within an electronic catalog of items that have an associated parametric value that corresponds to the numeric value included in the search query is less than a predetermined number of items.
